(19) United States
(12) Patent Application Publication
(10) Pub. No.: US 2006/0062308 A1
(43) Pub. Date: Mar. 23, 2006

(54) Processing video frames

(76) Inventors: Carl Staelin, Haifa (IL); Mani Fischer, Haifa (IL); Hila Nachlieli, Haifa (IL)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/946,940

(22) Filed: Sep. 22, 2004

(51) Int. Cl. H04N 11/04; H04N 7/12; H04B 1/66; H04N 11/02

(52) U.S. Cl. 375/240.18; 375/240.24

(57) ABSTRACT

Methods, machines, and computer-readable media storing machine-readable instructions for processing video frames are described. In one aspect, a respective set of three-dimensional forward transform coefficients is computed for each of multiple positions of a three-dimensional blocking grid relative to an input video block comprising a selected set of video frames. The sets of three-dimensional forward transform coefficients are processed. A respective three-dimensional inverse transform is computed from each set of processed forward transform coefficients. An output video block is generated based on the computed three-dimensional inverse transforms.

### BACKGROUND

Digital images and video frames are compressed in order to reduce data storage and transmission requirements. In most image compression methods, certain image data is discarded selectively to reduce the amount of data needed to represent the image while avoiding substantial degradation of the appearance of the image.

Transform coding is a common image compression method that involves representing an image by a set of transform coefficients. The transform coefficients are quantized individually to reduce the amount of data that is needed to represent the image. A representation of the original image is generated by applying an inverse transform to the transform coefficients. Block transform coding is a common type of transform coding method. In a typical block transform coding process, an image is divided into small rectangular regions (or “blocks”), which are subjected to forward transform, quantization and coding operations. Many different kinds of block transforms may be used to encode the blocks. Among the common types of block transforms are the cosine transform (which is the most common), the Fourier transform, the Hadamard transform, and the Haar wavelet transform. These transforms produce an M×N array of transform coefficients from an M×N block of image data, where M and N have integer values of at least 1.

The quality of images and video frames often are degraded by the presence of noise. A block transform coding process is a common source of noise in compressed image and video frames. For example, discontinuities often are introduced at the block boundaries in the reconstructed images and video frames, and ringing artifacts often are introduced near image boundaries.

### SUMMARY

The invention features methods, machines, and computer-readable media storing machine-readable instructions for processing video frames.

In one aspect, the invention features a method of processing a sequence of video frames. In accordance with this inventive method, a respective set of three-dimensional forward transform coefficients is computed for each of multiple positions of a three-dimensional blocking grid relative to an input video block comprising a selected set of video frames. The sets of three-dimensional forward transform coefficients are processed. A respective three-dimensional inverse transform is computed from each set of processed forward transform coefficients. An output video block is generated based on the computed three-dimensional inverse transforms.

The invention also features a machine and a computer-readable medium storing machine-readable instructions for implementing the above-described video sequence processing method.

Other features and advantages of the invention will become apparent from the following description, including the drawings and the claims.

### DESCRIPTION OF DRAWINGS

FIG. 1 is a block diagram of a prior art system for compressing a video sequence and decompressing the compressed video sequence.

FIG. 2 is a diagrammatic view of an exemplary video block composed of a set of video frames selected from an input video sequence.

FIG. 3 is a flow diagram of an embodiment of a method of processing a compressed video sequence to produce an output video sequence characterized by reduced compression artifacts.

FIG. 4 is a block diagram of an embodiment of a video sequence processing system for implementing the method of FIG. 3.

FIG. 5 is a graph of the output of a denoising filter plotted as a function of input transform coefficient values.

FIG. 6 is a block diagram of an implementation of the output video generator module in shown in FIG. 4.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of actual embodiments nor relative dimensions of the depicted elements, and are not drawn to scale.

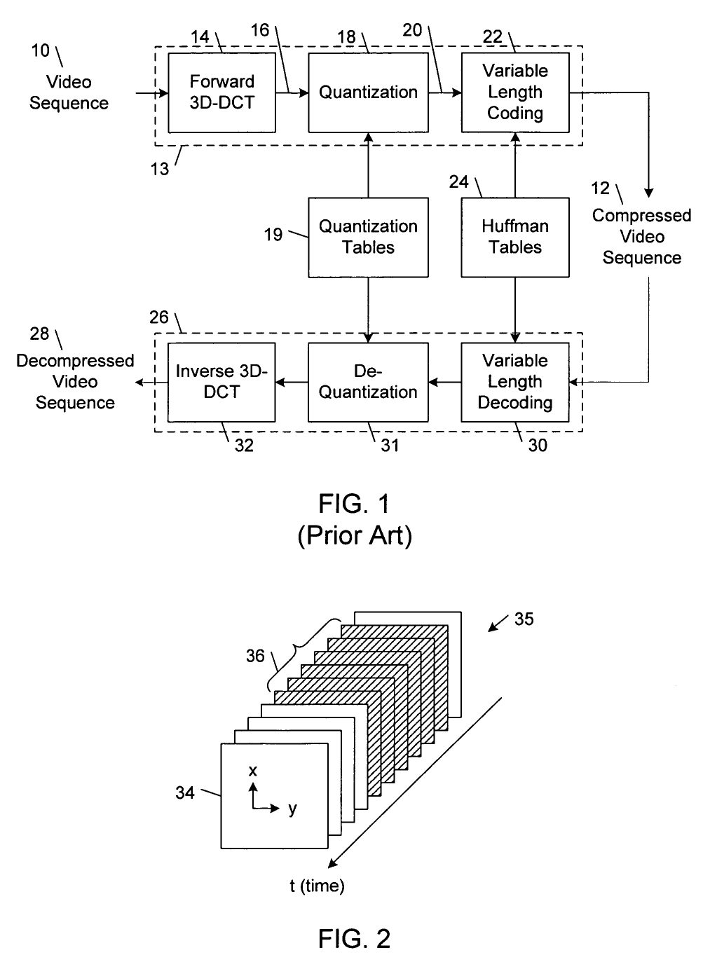

FIG. 1 shows a prior art method of processing an original video sequence 10 to produce a compressed video sequence 12. In accordance with the illustrated method, an encoding module 13 applies a forward three-dimensional (3D) discrete cosine transform (DCT) to the original video sequence 10 to produce a set of forward transform coefficients 16 (block 14). Typically, each color plane of each video frame is divided into blocks of pixels (e.g., 8×8 pixel blocks), so-called video blocks from a sequence of frames are generated (e.g., 8×8×8 pixel blocks), and the 3D DCT is applied to each video block. The encoding module 13 quantizes the forward transform coefficients 16 based on quantization tables 19 to produce a set of quantized forward coefficients 20 (block 18). During the quantization process 18, some of forward transform coefficient information is discarded, which enables the original video sequence 10 to be compressed. The encoding module 13 encodes the quantized forward transform coefficients using, for example, a variable length encoding technique based on Huffman tables 24 to produce the compressed video sequence 12 (block 22).

A decoding module 26 produces a decompressed video sequence 28 from the compressed video sequence 12 as follows. The decoding module 26 performs variable length decoding of the compressed video sequence 12 based on Huffman tables 24 (block 30). The decoding module 26 de-quantizes the decoded video data based on the same quantization tables 19 that were used to produce the compressed video sequence 12 (block 31). The decoding module 26 computes an inverse three-dimension DCT from the de-quantized video data to produce the decompressed video sequence 28 (block 32).

As explained above, the quality the resulting decompressed frames of the video sequence 28 often are degraded by noise and artifacts introduced by the 3D-DCT block transform coding process. For example, discontinuities often are introduced at the block boundaries in the reconstructed video frames, and ringing artifacts often are introduced near image boundaries.

The embodiments described below are configured to denoise video sequences. For example, these embodiments readily may be used to denoise home movies from sources like digital cameras, digital video cameras, and cell phones. These embodiments also may be used to reduce artifacts inherently introduced by processes that are used to create compressed video sequences, including JPEG/MPEG artifacts in compressed video streams, such as VCD/DVD/broadcast video streams. In many instances, these embodiments denoise and reduce video sequence compression artifacts without degrading video frame quality, such as by blurring features in the video frames. As described in detail below, some implementations of these embodiments are particularly well-suited to substantially reduce blocking compression artifacts that are introduced by block-transform-based compression techniques, such as block discrete cosine transform (DCT) compression techniques.

Referring to FIG. 2, the video frame processing embodiments described in detail below operate with respect to input video blocks 36 that are composed of respective sets of L video frames 34 that are selected from a video frame sequence 35, where L is a positive integer. Each input video block 36 is defined with respect to two spatial dimensions (x, y) and one temporal dimension (t) that corresponds to the temporal order of the frames 34 in the sequence 35.

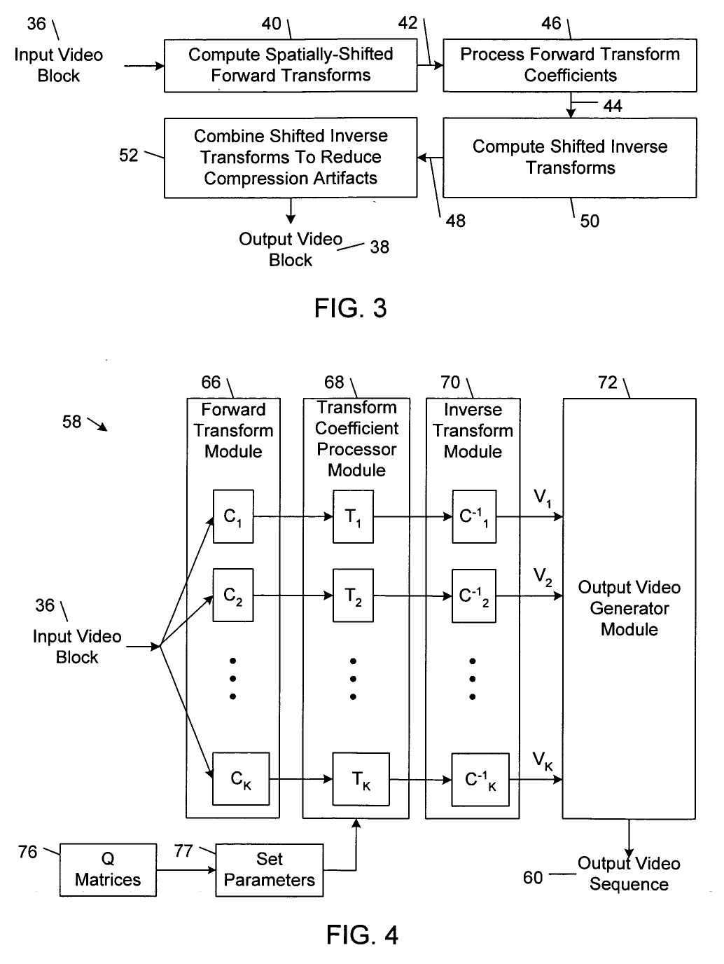

FIG. 3 shows an embodiment of a method of processing an input video block 36 to produce a denoised output video block 38. The video block 36 is composed of a selected set of the video frames in a video sequence that is generated by a block-transform-based image compression method, such as the method shown in FIG. 1. In the method of FIG. 3, the color planes of the frames in the video sequence are arranged into respective input video blocks 36 that are processed separately. If originally encoded (e.g., in accordance with a lossless encoding process), the frames of the input video block 36 initially are decoded before being processed as follows.

Spatiotemporally-shifted, three-dimensional forward transforms are computed from the input video block 36 (block 40). In this process, a forward transform operation is applied to each of multiple positions of a three-dimensional blocking grid relative to the input video block 36 to produce multiple respective sets of three-dimensional forward transform coefficients 42. In an implementation in which the input video block 36 was originally compressed based on blocks of L video frame patches of M×N pixels, the forward transform operation is applied to a subset of the input image data containing K shifts from the L×M×N independent shifts possible in an L×M×N transform to produce K sets of forward transform coefficients, where K, L, M, and N have integer values of at least 1. In one exemplary implementation, both M and N have a value of 8.

The three-dimensional forward transform coefficients 42 of each set are processed as explained in detail below to produce respective sets of processed forward transform coefficients 44 (block 46). In general, the forward transform coefficients 42 may be processed in any of a wide variety of different ways. In some implementations, a filter (e.g., a denoising filter, a sharpening filter, a bilateral filter, or a bi-selective filter) is applied to the forward transform coefficients 42. In other implementations, a transform (e.g., JPEG or MPEG) artifact reduction process may be applied to the forward transform coefficients 42.

An inverse transform operation is applied to each of the sets of processed forward transform coefficients 44 to produce respective shifted, three-dimensional inverse transforms 48 (block 50). In particular, the inverse of the forward transform operation that is applied during the forward transform process 40 is computed from the sets of processed forward transform coefficients 44 to generate the shifted inverse transforms 48.

As explained in detail below, the shifted inverse transforms 48 are combined to reduce noise and compression artifacts in the color planes of at least a subset of video frames in the input video block 36 (block 52). In some implementations, the resulting color component video planes (e.g., Cr and Cb) are converted back to the original color space (e.g., the Red-Green-Blue color space) of the input video block 36. The video planes then are combined to produce the output video block 38.

FIG. 4 shows an embodiment of a system 58 for processing the input video block 36 to produce a compression-artifact-reduced output video sequence 60. Processing system 58 includes a forward transform module 66, a transform coefficient processor module 68, an inverse transform module 70, and an output video generator module 72. In general, the modules 66-72 of system 58 are not limited to any particular hardware or software configuration, but rather they may be implemented in any computing or processing environment, including in digital electronic circuitry or in computer hardware, firmware, device driver, or software. For example, in some implementations, these modules 66-72 may be embedded in the hardware of any one of a wide variety of digital and analog electronic devices, including desktop and workstation computers, digital still image cameras, digital video cameras, printers, scanners, and portable electronic devices (e.g., mobile phones, laptop and notebook computers, and personal digital assistants).

A. Forward Transform Module

The forward transform module 66 computes from the input video block 36 K sets (C₁, C₂, . . . , C_{K}) of shifted forward transforms, corresponding to K unique positions of a three-dimensional blocking grid relative to the input video block 36. The shifting of the blocking grid near the boundaries of the video data may be accommodated using any one of a variety of difference methods, including symmetric or anti-symmetric extension, row, column and temporal replication, and zero-shift replacement. In some implementations, an anti-symmetric extension is performed in each of the spatial and temporal dimensions. In one exemplary approach, the temporal dimension is divided into blocks and the video frame data is taken as the extension in the temporal dimension.

In one example, each three-dimensional block of the forward transform is computed based on a unitary frequency-domain transform D. Each block of the spatiotemporally-shifted forward transforms C₁ (1=1, 2, . . . , K) may be computed based on the separable application of the transform D in three dimensions as follows:
B=DXD^{T} (4)
where X corresponds to the input video block 36, D^{T} corresponds to the transpose of transform D, and B corresponds to the transform coefficients of the input video block X.

In some implementations, D is a block-based linear transform, such as a discrete cosine transform (DCT). In one dimension, the DCT transform is given to four decimal places by the following 8 by 8 matrix:

$$D = \begin{matrix}0.3536 & 0.3536 & 0.3536 & 0.3536 & 0.3536 & 0.3536 & 0.3536 & 0.3536 \\ 0.4904 & 0.4157 & 0.2778 & 0.0975 & - 0.0975 & - 0.2778 & - 0.4157 & - 0.4904 \\ 0.4619 & 0.1913 & - 0.1913 & - 0.4619 & - 0.4619 & - 0.1913 & 0.1913 & 0.4619 \\ 0.4157 & - 0.0975 & - 0.4904 & - 0.2778 & 0.2778 & 0.4904 & 0.0975 & - 0.4157 \\ 0.3536 & - 0.3536 & - 0.3536 & 0.3536 & 0.3536 & - 0.3536 & - 0.3536 & 0.3536 \\ 0.2778 & - 0.4904 & 0.0975 & 0.4157 & - 0.4157 & - 0.0975 & 0.4904 & - 0.2778 \\ 0.1913 & - 0.4619 & 0.4619 & - 0.1913 & - 0.1913 & 0.4619 & - 0.4619 & 0.1913 \\ 0.0975 & - 0.2778 & 0.4157 & - 0.4904 & 0.4904 & - 0.4157 & 0.2778 & - 0.0975\end{matrix} \qquad ( 5 )$$

In some implementations, the blocks of the spatiotemporally-shifted forward transforms (C₁, C₂, . . . , C_{K}) are computed based on a factorization of the transform D, as described in U.S. Pat. No. 6,473,534, for example.

In some other implementations, D is a wavelet-based decomposition transform. In one of these implementations, for example, D may be a forward discrete wavelet transform (DWT) that decomposes a one-dimensional (1-D) sequence into two sequences (called sub-bands), each with half the number of samples. In this implementation, the 1-D sequence may be decomposed according to the following procedure: the 1-D sequence is separately low-pass and high-pass filtered by an analysis filter bank; and the filtered signals are downsampled by a factor of two to form the low-pass and high-pass sub-bands.

B. Transform Coefficient Processor Module

The transform coefficient processor module 68 processes the sets of forward transform coefficients 42 corresponding to the spatiotemporally-shifted forward transforms (C₁, C₂, . . . , C_{K}) that are computed by the forward transform module 66. In one exemplary implementation, the transform coefficient processor module 68 denoises the sets of forward transform coefficients 42 by nonlinearly transforming the forward transform coefficients (C₁, C₂, . . . , C_{K}) that are computed by the forward transform module 66.

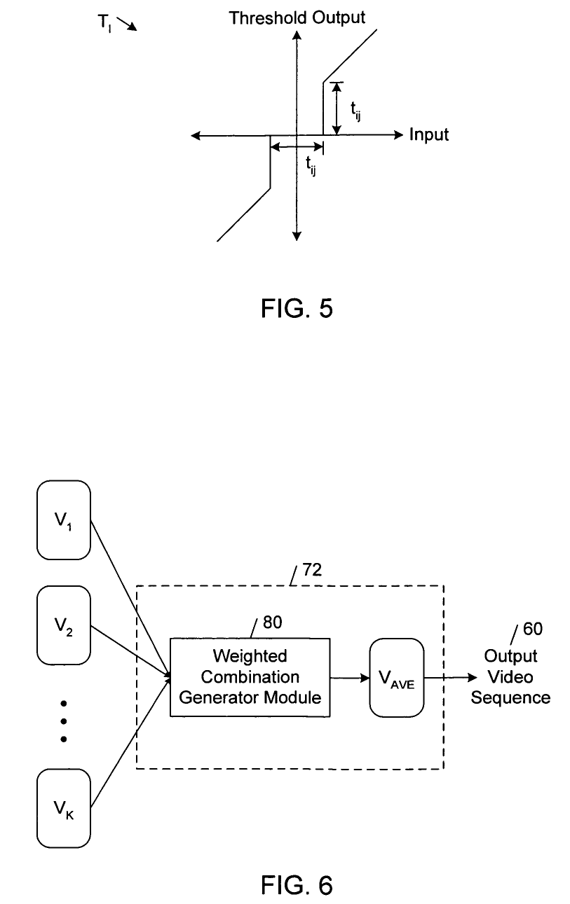

In some implementations, the transform coefficient processor module denoises the sets of three-dimensional forward transform coefficients by applying at least one of the following to the sets of forward transform coefficients: a soft threshold; a hard threshold; a bilateral filter; or a bi-selective filter Referring to FIG. 5, in some implementations, the sets of forward transform coefficients are transformed in accordance with respective nonlinear thresholding transformations (T₁, T₂, . . . , T_{K}). In the illustrated implementation, the forward transform coefficients are nonlinearly transformed in accordance with a soft threshold by setting to zero each coefficient with an absolute value below a respective threshold (tᵢⱼ, where i, j refer to the indices of the quantization element, with i having values in the range of 0 to M-1 and j having values in the range of 0 to N-1) and leaving unchanged each coefficient with an absolute value equal to or above a respective threshold (tᵢⱼ). Quantization matrices 76 (or “Q Matrices”) can be used to set the parameters tᵢⱼ for the nonlinear thresholding transformations (T₁, T₂, . . . , T_{K}). In some of these implementations, the quantization matrices contain the same quantization parameters qᵢⱼ that were originally used to is compress video sequence 12. These quantization parameters may be stored in the compressed image 12 in accordance with a standard video compression scheme (e.g., MPEG). In some implementations, the threshold parameters are set in block 77 by a function M that maps the quantization parameters qᵢⱼ of the Q matrices to the corresponding threshold parameters. In other implementations, the thresholds are determined by the parameters used to describe the marginal distribution of the coefficients.

In some implementations, the parameters of the nonlinear thresholding transformations (T₁, T₂, . . . , T_{K}) are the same for the entire input video block 36. In other implementations, the parameters of the nonlinear thresholding transformations (T₁, T₂, . . . , T_{K}) may vary for different regions of the input video block 36. In some implementations, the threshold parameters vary according to video frame content (e.g., face region or textured region). In other implementations, threshold parameters vary based on transform component.

In some implementations, the transform coefficient processor module 68 processes the sets of three-dimensional forward transform coefficients 42 by applying a transform artifact reduction process to the sets of forward transform coefficients 42. In some exemplary implementations, the transform artifact reduction process is applied instead of or in addition to (e.g., after) the process of denoising the sets of forward transform coefficients.

C. Inverse Transform Module

The inverse transform module 70 computes sets of inverse transforms (C⁻¹₁, C⁻¹₂, . . . , C⁻¹_{K}) from the sets of processed forward transform coefficients 44. The inverse transform module 70 applies the inverse of the forward transform operation that is applied by forward transform module 66. The outputs of the inverse transform module 70 are intermediate video blocks (V₁, V₂, . . . , V_{K}) representing the video data in the spatial and temporal domains. The terms inverse transforms (C⁻¹₁, C⁻¹₂, . . . C⁻¹_{K}) and intermediate video blocks (V₁, V₂, . . . , V_{K}) are used synonymously herein. The blocks of the spatiotemporally-shifted inverse transforms (C⁻¹′₁, C⁻¹₂, . . . , C⁻¹_{K}) may be computed from equation (6):
C⁻¹=D⁻¹F(D^{T})⁻¹ (6)
where F corresponds to output of the transform domain filter module 68, D is the forward transform, D⁻¹ is the inverse transform, and D^{T} is the transpose of the transform D.

D. Output Image Generator Module

The output video generator module 72 combines the intermediate video blocks (V₁, V₂, . . . , V_{K}) to form the video planes of the output video sequence 60. In general, the output image generator module 72 computes the output video sequence 60 based on a function of some or all of the intermediate video blocks (V₁, V₂, . . . , V_{K}). For example, in some implementations, the video sequence 60 is computed from a weighted combination of the intermediate video blocks (V₁, V₂, . . . , V_{K}). In general, the weights may be constant for a given output video sequence 60 being constructed or they may vary for different regions of the given output video sequence 60. For example, in one of these implementations, the output video sequence 60 corresponds to a weighted average of the intermediate video blocks (V₁, V₂, . . . , V_{K}). In other implementations, the weights may be a function of the transform coefficient magnitude, or measures of video frame content (e.g., texture or detected faces). In some of these implementations, the weights of the intermediate video blocks (Vⱼ) that correspond to blocks with too many coefficients above a given threshold (which indicates edge or texture in the original video data) are set to zero, and only the intermediate video blocks that are obtained from blocks with more coefficients below the threshold are used to compute the output video sequence 60. In other of these implementations, the output video sequence 60 corresponds to the median of the intermediate video blocks (V₁, V₂, . . . , V_{K}).

FIG. 6 shows an embodiment of the output video generator module 72 that includes a weighted combination generator module 80 that computes a base video block (V_{AVE}) from a combination of the intermediate video blocks (V₁, V₂, . . . , V_{K}). The base video block corresponds to an estimate of the original uncompressed version of the input video block 36. In the illustrated embodiment, weighted combination generator module 80 computes a base video block (V_{AVE}) that has pixel values corresponding to averages of corresponding pixels in the intermediate video blocks (V₁, V₂, . . . , V_{K}).

Other embodiments are within the scope of the claims.

For example, although the above denoising and compression artifact reduction embodiments are described in connection with an input video block 36 that is compressed by a block-transform-based video compression method, these embodiments readily may be used to denoise and/or reduce artifacts in video sequences compressed by other non-block-transform-based video compression techniques.

What is claimed is:

1. A method of processing a sequence of video frames, comprising:
computing a respective set of three-dimensional forward transform coefficients for each of multiple positions of a three-dimensional blocking grid relative to an input video block comprising a selected set of video frames;
processing the sets of three-dimensional forward transform coefficients;
computing a respective three-dimensional inverse transform from each set of processed forward transform coefficients; and
generating an output video block based on the computed three-dimensional inverse transforms.

2. The method of claim 1, wherein the forward transform coefficients are computed based on a block-based linear transform.

3. The method of claim 2, wherein the three-dimensional inverse transforms are computed based on three-dimensional blocking grids used to compute three-dimensional forward transforms corresponding to the sets of forward transform coefficients.

4. The method of claim 2, wherein the forward transform coefficients are computed based on a discrete cosine transform.

5. The method of claim 1, wherein processing the sets of three-dimensional forward transform coefficients comprises denoising the sets of forward transform coefficients based on nonlinear mappings of input coefficient values to output coefficient values.

6. The method of claim 5, wherein denoising comprises applying at least one of the following to the sets of three-dimensional forward transform coefficients: a soft threshold; a hard threshold; a bilateral filter; or a bi-selective filter.

7. The method of claim 1, wherein processing the sets of forward transform coefficients comprises applying an artifact reduction process to the sets of forward transform coefficients.

8. The method of claim 1, wherein generating the output video block comprises combining three-dimensional inverse transforms.

9. The method of claim 8, wherein combining three-dimensional inverse transforms comprises computing a weighted combination of the three-dimensional inverse transforms.

10. The method of claim 9, wherein the output video block corresponds to a weighted average of the three-dimensional inverse transforms.

11. The method of claim 9, wherein the weighted combination is computed based on weights that vary as a function of transform coefficient magnitude.

12. The method of claim 9, wherein the weighted combination is computed based on weights that vary as a function of video frame content.

13. A machine for processing a sequence of video frames, comprising:
a forward transform module configured to compute a respective set of three-dimensional forward transform coefficients for each of multiple positions of a three-dimensional blocking grid relative to an input video block comprising a selected set of video frames;
a transform coefficient processor module configured to process the sets of three-dimensional forward transform coefficients;
an inverse transform module configured to compute a respective three-dimensional inverse transform from each set of processed forward transform coefficients; and
an output image generator module configured to generate an output video block based on the computed three-dimensional inverse transforms.

14. The machine of claim 13, wherein the forward transform module computes the forward transform coefficients based on a block-based linear transform.

15. The machine of claim 14, wherein the inverse transform module computes the three-dimensional inverse transforms based on three-dimensional blocking grids used to compute three-dimensional forward transforms corresponding to the sets of forward transform coefficients.

16. The machine of claim 14, wherein the forward transform module computes the forward transform coefficients based on a discrete cosine transform.

17. The machine of claim 13, wherein the transform coefficient processor module processes the sets of three-dimensional forward transform coefficients by denoising the sets of forward transform coefficients based on nonlinear mappings of input coefficient values to output coefficient values.

18. The machine of claim 17, wherein the transform coefficient processor module denoises the forward transform coefficients by applying at least one of the following to the sets of three-dimensional forward transform coefficients: a soft threshold; a hard threshold; a bilateral filter; or a bi-selective filter.

19. The machine of claim 13, wherein transform coefficient processor module processes the sets of forward transform coefficients by applying an artifact reduction process to the sets of forward transform coefficients.

20. The machine of claim 13, wherein the output image generator module generates the output video block by combining three-dimensional inverse transforms.

21. The machine of claim 20, wherein the output image generator module combines three-dimensional inverse transforms by computing a weighted combination of the three-dimensional inverse transforms.

22. The machine of claim 21, wherein the output video block corresponds to a weighted average of the three-dimensional inverse transforms.

23. The machine of claim 21, wherein the output image generator module computes the weighted combination based on weights that vary as a function of transform coefficient magnitude.

24. The machine of claim 21, wherein the output image generator module computes the weighted combination based on weights that vary as a function of video frame content.

25. A machine-readable medium storing machine-readable instructions for causing a machine to:
compute a respective set of three-dimensional forward transform coefficients for each of multiple positions of a three-dimensional blocking grid relative to an input video block comprising a selected set of video frames;
process the sets of three-dimensional forward transform coefficients;
compute a respective three-dimensional inverse transform from each set of processed forward transform coefficients; and
generate an output video block based on the computed three-dimensional inverse transforms.

26. The machine-readable medium of claim 25, wherein the machine-readable instructions cause the machine to compute the forward transform coefficients based on a block-based linear transform.

27. The machine-readable medium of claim 26, wherein the machine-readable instructions cause the machine to compute the three-dimensional inverse transforms based on three-dimensional blocking grids used to compute three-dimensional forward transforms corresponding to the sets of forward transform coefficients.

28. The machine-readable medium of claim 26, wherein the machine-readable instructions cause the machine to compute the forward transform coefficients based on a discrete cosine transform.

29. The machine-readable medium of claim 25, wherein the machine-readable instructions cause the machine to process the sets of three-dimensional forward transform coefficients by denoising the sets of forward transform coefficients based on nonlinear mappings of input coefficient values to output coefficient values.

30. The machine-readable medium of claim 29, wherein the machine-readable instructions cause the machine to denoise the sets of forward transform coefficients by applying at least one of the following to the sets of three-dimensional forward transform coefficients: a soft threshold; a hard threshold; a s bilateral filter; or a bi-selective filter.

31. The machine-readable medium of claim 25, wherein the machine-readable instructions cause the machine to process the sets of forward transform coefficients by applying an artifact reduction process to the sets of forward transform coefficients.

32. The machine-readable medium of claim 25, wherein the machine-readable instructions cause the machine to combine three-dimensional inverse transforms.

33. The machine-readable medium of claim 32, wherein the machine-readable instructions cause the machine to compute a weighted combination of the three-dimensional inverse transforms.

34. The machine-readable medium of claim 33, wherein the output video block corresponds to a weighted average of the three-dimensional inverse transforms.

35. The machine-readable medium of claim 33, wherein the machine-readable instructions cause the machine to compute the weighted combination based on weights that vary as a function of transform coefficient magnitude.

36. The machine-readable medium of claim 33, wherein the machine-readable instructions cause the machine to compute the weighted combination based on weights that vary as a function of video frame content.

37. A system for processing a sequence of video frames, comprising:
means for computing a respective set of three-dimensional forward transform coefficients for each of multiple positions of a three-dimensional blocking grid relative to an input video block comprising a selected set of video frames;
means for processing the sets of three-dimensional forward transform coefficients;
means for computing a respective three-dimensional inverse transform from each set of processed forward transform coefficients; and
means for generating an output video block based on the computed three-dimensional inverse transforms.
